(19) United States
(12) Patent Application Publication
(10) Pub. No.: US 2022/0235515 A1
(43) Pub. Date: Jul. 28, 2022

(54) STACKING DEVICE AND SYSTEM

(71) Applicant: Jakprints, Inc., Cleveland, OH (US)

(72) Inventor: Jacob Edwards, Willoughby, OH (US)

(21) Appl. No.: 17/583,348

(22) Filed: Jan. 25, 2022

Related U.S. Application Data
(60) Provisional application No. 63/141,661, filed on Jan. 26, 2021.

(51) Int. Cl. D06F 95/00; B65G 57/03; B65G 21/14; D06F 93/00

(52) U.S. Cl. CPC D06F 95/00; B65G 57/035; B65G 21/14; B65G 23/04; B65G 2203/0233; B65G 2203/0241; B65G 2201/0229; D06F 93/00

(57) ABSTRACT

Disclosed herein are systems and devices which transport and stack flexible textile workpieces (e.g., clothing) in a processing line. A proposed stacking device includes a conveyor belt wound through a series of rollers which permit horizontal extension of the conveyor path toward a downstream workstation. The extendable conveyor path allows for easy transferring and stacking of the workpieces at the downstream workstation.

### CROSS-REFERENCE TO RELATED APPLICATIONS

This application claims priority to U.S. Provisional Patent Application Ser. No. 63/141,661, filed on Jan. 26, 2021, which is incorporated by reference in its entirety.

### BACKGROUND

The present disclosure relates generally to the transportation and stacking of flexible textile workpieces in a processing line. More specifically, the present disclosure sets forth devices and systems configured to achieve said transportation and stacking.

Automated machinery is widely used in the manufacture of thin flexible textile workpieces, such as clothing and apparel like t-shirts. However, some manufacturing steps are still performed manually.

For example, in existing processing lines, human actors are often required to manually remove t-shirts from one workstation and manually transfer and stack the t-shirts to be ready for final shipment or further processing. Flexible textile workpieces like t-shirts can be difficult to handle quickly and in a controlled manner. These manual transferring and stacking processes are known to be time-consuming, and result in a poor cost-benefit ratio.

Thus, a need exists for a device, system, and/or method which addresses the issues associated with apparel manufacturing discussed above.

### BRIEF DESCRIPTION

The present disclosure is generally directed to a system and device which transports and stacks thin textile workpieces (e.g., clothing) in a processing line. The proposed stacking device includes a conveyor belt wound through a series of rollers which permit horizontal extension of the conveyor path. The extendable conveyor path allows for easy transferring and stacking of the workpieces at a subsequent downstream workstation.

Individual workpieces are transported from an upstream workstation, to the conveyor belt of the stacking device, and finally to a downstream workstation which can be configured as a height-adjustable stacking table. Once a workpiece reaches the stacking device from the upstream workstation, the conveyor belt advances the workpiece in the direction of the downstream table. The belt stops advancing forward when a sensor detects the workpiece at a predetermined checkpoint. The length of the conveyor belt remains constant during this stage.

Next, a linear actuator powers a carriage forward in the direction of the downstream stacking table, thereby extending the length of the conveyor belt. This can be achieved in part by a sliding cam roller, which moves in the same direction as the carriage to free-up additional portions of the belt. The carriage continues moving forward until it reaches a fully extended position, where the front of the carriage extends a sufficient distance past the front of the downstream stacking table such that the workpiece can be deposited and fully supported on top of the table.

Once the carriage is in its fully extended position, the workpiece is deposited onto the table by advancing the conveyor belt forward while simultaneously moving the carriage rearward toward its starting point. The process then restarts with a new workpiece and continues until a stack of workpieces is formed to a desired capacity. As the workpieces accumulate, the height-adjustable table automatically lowers to accommodate the growing stack and ensure that subsequent workpieces continue to stack upon prior workpieces in a neat and orderly manner. Moreover, the height-adjustable table can also include its own separate conveyor belt to move the entire stack of workpieces to another location for further processing.

Thus disclosed in various embodiments are systems for handling textile workpieces comprising: a first workstation, a stacking device workstation, and a second workstation. The first workstation includes a support surface from which workpieces are fed. The stacking device workstation includes a stationary frame, a workpiece receiving end, a workpiece depositing end, a linearly displaceable carriage mounted to the stationary frame and moveable between a starting position and a fully extended position, a conveyor belt with a support surface to receive and transfer said workpieces from the first workstation, and a plurality of rollers engaged with the conveyor belt, the plurality of rollers comprising: a driver roller mounted on the stationary frame, at least two fixed support rollers mounted on the stationary frame, a moving roller mounted below the carriage, and a delivery roller mounted on a front end of the carriage, wherein the moving roller and the delivery rollers move relative to the fixed support rollers and stationary frame to change a length of the conveyor belt. The second workstation includes a support surface to receive said workpieces from the workpiece depositing end of the stacking device.

The stacking device workstation may further comprise a linear actuator configured to linearly displace the carriage between the starting position and the fully extending position.

The stacking device workstation may further comprise a sensor disposed above the stacking device conveyor belt for detecting the presence of workpieces.

The second workstation may be a height-adjustable stacking table. The support surface of the second workstation may be positioned below the support surface of the stacking device conveyor belt.

The first workstation may be a dryer conveyor positioned upstream of the stacking device, the dryer conveyor including a conveyor belt defining a support surface from which workpieces are fed. The support surface of the dryer conveyor belt may be above or coplanar with the support surface of the stacking device conveyor belt

Also disclosed herein are stacking devices for transferring workpieces between an upstream workstation and a downstream workstation, the stacking device comprising: a stationary frame, a workpiece receiving end, and a workpiece depositing end; a linearly displaceable carriage mounted to the stationary frame and moveable between a starting position and a fully extended position; a conveyor belt with a support surface to receive said workpieces from the upstream workstation and transfer said workpieces to the downstream workstation; and a plurality of rollers engaged with the conveyor belt and extending between the sidewalls, the plurality of rollers comprising a driver roller mounted on the stationary frame, at least two fixed support rollers mounted on the stationary frame, a moving roller mounted below the carriage, and a delivery roller mounted on a front end of the carriage, wherein the moving roller and the delivery rollers move relative to the fixed support rollers and stationary frame to change a length of the conveyor belt.

The stacking device may further comprise a sensor disposed above the conveyor belt for counting and detecting the presence of workpieces, the sensor being operatively connected with the controller.

The stacking device may further comprise a linear actuator and an associated motor configured to move the carriage between the starting position and the fully extending position, the linear actuator and associated motor being operatively connected with the controller.

The stacking device may further comprise two mutually parallel sidewalls supported by the stationary frame. The sidewalls can include a cantilevered portion defining a protrusion which extends toward the downstream workstation. The sidewalls may also include longitudinal tracks on which the carriage is guided between the starting position and the fully extended position.

The stacking may further comprise a motor for moving the conveyor belt and a controller for controlling the operation of the conveyor belt and the carriage, the motor being operatively connected with the controller.

Also disclosed herein are methods for stacking workpieces, comprising: receiving a workpiece at a stacking device that comprises: a stationary frame, a workpiece receiving end, and a workpiece depositing end; a linearly displaceable carriage mounted to the stationary frame and moveable between a starting position and a fully extended position; a conveyor belt with a support surface to receive said workpieces from the upstream workstation and transfer said workpieces to the downstream workstation; and a plurality of rollers engaged with the conveyor belt and extending between the sidewalls, the plurality of rollers comprising a driver roller mounted on the stationary frame, at least two fixed support rollers mounted on the stationary frame, a moving roller mounted below the carriage, and a delivery roller mounted on a front end of the carriage, wherein the moving roller and the delivery rollers move relative to the fixed support rollers and stationary frame to change a length of the conveyor belt; rotating the conveyor belt at a forward feed speed so that the workpiece travels to a front end of the carriage; moving the carriage from the starting position to the fully extended position such that the length of the conveyor belt increases; and moving the conveyor belt at the forward feed speed while moving the carriage from the fully extended position to the starting position, such that the workpiece travels off the conveyor belt while the length of the conveyor belt decreases, and the workpiece is stacked.

The carriage may move from the starting position to the fully extended position when a sensor disposed above the stacking device conveyor belt detects the presence of the workpiece at the front end of the carriage.

In some embodiments, the forward feed speed of the conveyor belt is reduced to zero while the carriage moves from the starting position to the fully extended position, such that the workpiece is stacked in its original received orientation.

In other embodiments, the forward feed speed of the conveyor belt is maintained while the carriage moves from the starting position to the fully extended position, such that the workpiece is flipped from its original received orientation.

The stacking device can receive the workpiece from an upstream conveyor belt. A feed speed of the upstream conveyor belt may be from about 60 to 75% of the forward feed speed of the stacking device conveyor belt.

These and other non-limiting characteristics of the disclosure are more particularly disclosed below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a schematic illustration of a system for processing sheet-like workpieces in accordance with the present disclosure, which includes an intermediate transferring and stacking device positioned between associated upstream and downstream workstations.

FIG. 2 is a side view illustration showing the stacking device of FIG. 1.

FIG. 3 is a side view illustration of the stacking device of FIG. 2 which shows the linear displacement of a carriage and a conveyor belt during a transfer and process of a thin textile workpiece.

FIG. 4 is a side view illustration of the stacking device of FIG. 2, with the carriage and conveyor belt in a fully extended position.

FIG. 5 is a perspective view illustration of a system for processing sheet-like workpieces which includes the stacking device of FIG. 2 being operatively associated with a downstream height-adjustable stacking table.

FIG. 6 is a side view illustration of the system of FIG. 5, showing the operative association of the stacking device and the height-adjustable stacking table.

FIG. 7 is a side view illustration showing additional detail of the height adjustable stacking table of the system of FIG. 5.

FIG. 8 is a side view illustration of a system for processing sheet-like workpieces which includes the stacking device of FIG. 2 operatively associated with an upstream dryer conveyor and the downstream height-adjustable stacking table of FIG. 7.

### DETAILED DESCRIPTION

A more complete understanding of the components, processes and apparatuses disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used in the specification and in the claims, the terms “comprise(s),” “include(s),” “having,” “has,” “can,” “contain(s),” and variants thereof, as used herein, are intended to be open-ended transitional phrases, terms, or words that require the presence of the named components/ingredients/steps and permit the presence of other components/ingredients/steps. However, such description should be construed as also describing systems or devices or compositions or processes as “consisting of” and “consisting essentially of” the enumerated components/ingredients/steps, which allows the presence of only the named components/ingredients/steps, along with any unavoidable impurities that might result therefrom, and excludes other components/ingredients/steps.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

A value modified by a term or terms, such as “about” and “substantially,” may not be limited to the precise value specified. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number.

The terms “upper” and “lower” are relative to each other in location, i.e. an upper component is located at a higher elevation than a lower component.

The terms “upstream” and “downstream” are relative to the direction in which a workpiece flows through various components, i.e. the workpiece passes through an upstream component prior to passing through the downstream component.

The terms “horizontal” and “vertical” are used to indicate direction relative to an absolute reference, i.e. ground level. However, these terms should not be construed to require structures to be absolutely parallel or absolutely perpendicular to each other, and should permit up to 10° deviation.

The term “single” is used herein to indicate that only one of the indicated component is present, and to exclude the presence of additional identical components. For example, “a single widget” should be interpreted to mean one widget is present, and values of, for example, two widgets or three widgets are excluded.

As previously mentioned, the present disclosure is directed to a system and device for stacking flexible textile workpieces (e.g., clothing) in a processing line. Referring now to the drawings, various systems are shown for processing sheet-like workpieces 108 in a production line. While the workpieces 108 in the various embodiments are shown and described to specifically comprise items of clothing or apparel such as t-shirts, it is contemplated that other flexible textile objects could similarly be processed by the systems and devices disclosed herein. The stacking systems can be configured to stack the workpieces face-up or face-down, depending on its operation.

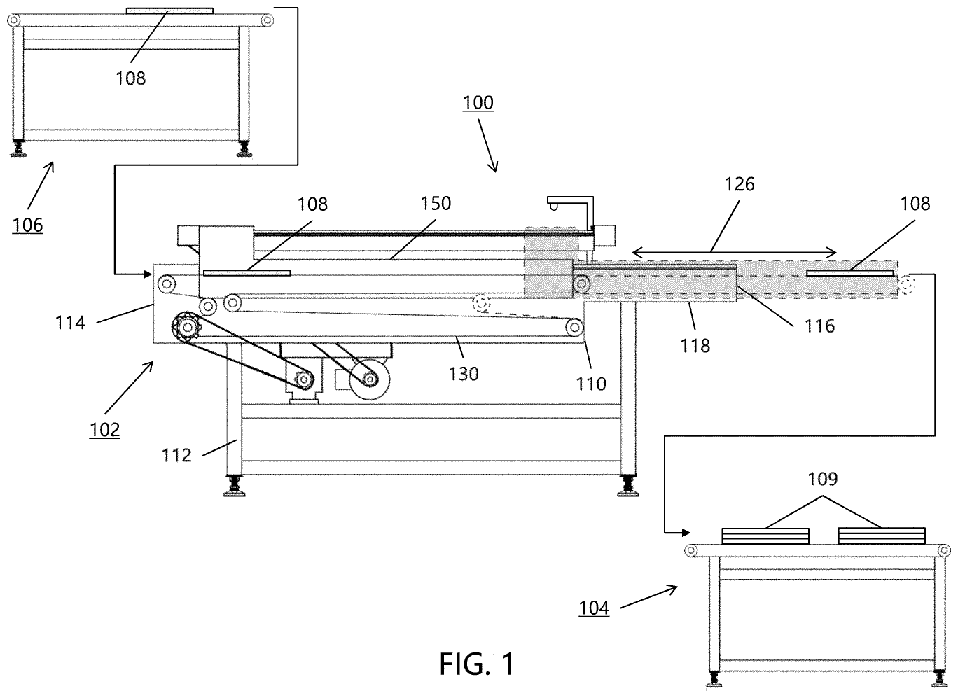

Referring first to FIG. 1, the workpiece processing systems of the present disclosure include a stacking device 102 for transferring, depositing, and stacking the workpieces 108 into one or more stacks 109. The stacking device 102 is arranged as an intermediate workstation in operative association with downstream workstation 104 and upstream workstation 106. The upstream workstation 106 is generally configured to feed or transport workpieces 108 to the stacking device 102. The downstream workstation 104 is generally configured to receive the workpieces in stacked form 109 from the stacking device 102.

The stacking device 102 has a base composed of two mutually parallel sidewalls 110 supported by a frame 112 and has a rectangular configuration which extends between a first or receiving end 114, and a second or depositing end 116. Generally, only one sidewall 110 is visible in the drawings, so that all components of the stacking device can be seen more easily. The sidewalls 110 may include a cantilevered portion 118 protruding from the second end 116 which extends toward the downstream workstation 104 when operatively connected therewith. The stacking device 102 includes a conveyor belt 130 which is extendable via a longitudinally/horizontally displaceable carriage 150 which moves back and forth in the direction of arrow 126. The fully extended position of the carriage 150 and conveyor belt 130 is indicated by the dashed lines outlining the carriage shown in FIG. 1.

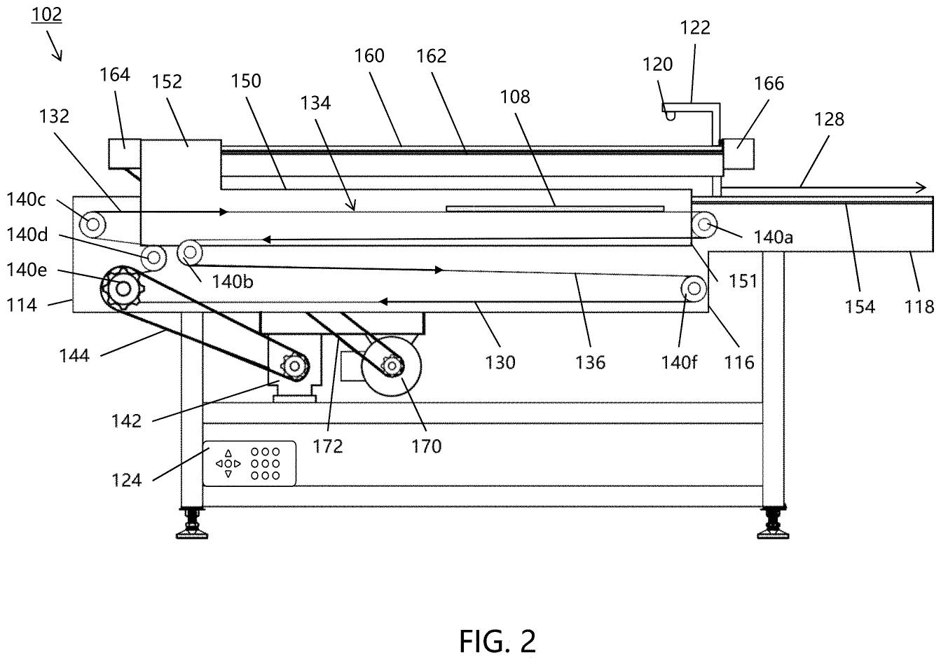

FIG. 2 shows additional details of the stacking device 102. A sensor 120 for detecting the presence of workpiece 108 and counting the total number of workpieces is mounted to a support arm 122 such that the sensor is generally disposed above the stacking device 102, or so the sensor can detect workpieces located on the conveyor belt. The sensor 120 is generally located upstream of cantilevered portion 118. The sensor 120 is in operative connection with a control mechanism 124 for adjusting and controlling the stacking device 102 and its various components.

More particularly, the control mechanism 124 of stacking device 102 instructs the operation of the extendable conveyor belt 130 and the longitudinally displaceable carriage 150 which can move in the direction of arrow 128. The conveyor belt 130 extends between a plurality of rollers 140a-140f mounted between sidewalls 110 via appropriate bearings (not shown) to provide an upper belt run 132 and a lower belt run 136. The upper belt run 132 defines a support surface 134 for supporting a workpiece 108 being transported by the stacking device 102. The lower belt run 136 has a variable length which, as discussed in further detail below, allows for the length of the upper belt run 132 to be extended. The conveyor belt 130 is made of a material with the desired tack for gripping the workpiece.

Some of the rollers 140a-140f are mounted to the sidewalls 110 or frame 112, while others may be mounted to the carriage 150. Thus, the plurality of rollers 140a-140f are configured as being either fixed (i.e., no linear motion) or longitudinally displaceable with respect to the sidewalls 110.

As shown in FIG. 2, delivery roller 140a, also referred to as a displaceable delivery roller, is mounted to the front end 151 of carriage 150 and is thus longitudinally displaceable with respect to the sidewalls 110.

Roller 140b, also referred to as a moving roller or a sliding cam roller, is mounted to the sidewalls 110 via a sliding cam (not shown) and is positioned below and behind the delivery roller 140a. The sliding cam permits roller 140b to move longitudinally along with the carriage 150 when activated by actuator 160. As such, the sliding cam roller 140b provides tension to the belt 130, ensuring that no slack occurs during movement of the carriage 150.

Remaining rollers 140c-140f are mounted in fixed relation to the sidewalls 110 and are thus not longitudinally displaceable with respect thereto. In general, fixed support roller 140c, fixed support roller 140d, and driver roller 140e are mounted closer to the receiving end 114 than delivery roller 140a, moving roller 140b, and fixed support roller 140f. Moving roller 140b can be described as being able to move longitudinally between rollers 140c-140e and roller 140f.

Fixed support roller 140c is mounted adjacent the first end 114 of sidewalls 110, and acts as the point where the workpiece 108 is received from the upstream workstation 106 shown in FIG. 1. Delivery roller 140a and fixed support roller 140c are mounted in a spaced apart but horizontally co-linear relation such that the upper run 132 of the conveyor belt 130 maintains a horizontal and flat support surface 134.

Fixed support roller 140d is mounted below the fixed support roller 140c and above driver roller 140e and maintains tension in the portion of belt 130 which extends between these three rollers.

Driver roller 140e is operatively engaged with motor 142 via chain or belt 144 to drive the conveyor belt 130 in the direction indicated by the arrows shown in FIG. 2. Moreover, motor 142 is in operative connection with the control mechanism 124 for adjusting and controlling the conveyor belt 130 of the stacking device 102. It is noted that the motor shaft could be moved to replace the driver roller, such that a chain or belt 144 is not needed.

Finally, fixed support roller 140f is mounted adjacent the second end 116 of sidewalls 110 to provide support for the lower run 136 of belt 130 along with sliding cam roller 140b.

Rollers 140a, 140c, 140e, and 140f could be described as contacting an interior surface of conveyor belt 130, while rollers 140b and 140d contact the exterior surface of conveyor belt 130.

The carriage 150 includes a vertically extending boss portion 152 operatively connected with a linear guide track 162 of the linear actuator 160. The actuator 160 is mounted to the sidewalls 110 and extends between a driving end 164 and idler end 166 such that the linear guide track 162 is positioned above and extends generally parallel to conveyor belt 130. As such, the carriage 150 can move back and forth with respect to the sidewalls 110 and the linear actuator 160 provides for such back and forth movement.

A support mechanism for the carriage 150 comprises longitudinal tracks 154 mounted to sidewalls 110 on which the carriage is guided by means of rollers (not shown) so as to be easily longitudinally displaceable and resistant to tilting when acted upon by the actuator 160. Both the driving and idler ends 164, 166 of the actuator 160 include a safety stop (not shown) for abutment with boss 152 to prevent over-extension of the carriage 150 in either direction. The actuator 160 is powered by a motor 170 operatively connected to the driving end 164 via chain or belt 172. Moreover, motor 170 is in operative connection with the control mechanism 124 for adjusting and controlling the carriage 150 and actuator 160 of the stacking device 102.

The operation of the stacking device 102 of the present disclosure during the transferring, depositing, and stacking process is illustrated in FIGS. 1-4.

Referring first to FIG. 1 and FIG. 2, the workpiece 108 is moved from upstream workstation 104 to engage the support surface 134 of the upper belt run 132 at the receiving roller 140c. The carriage 150 is located in the starting or retracted position shown in FIG. 2. The workpiece 108 moves forward or to the right in the stacking device 102, as indicated by the arrow 128 in FIG. 2, until a front edge of the workpiece is detected by sensor 120. The sensor can operate by any suitable means, for example by detecting a change in proximity/depth or a change in color, or generally any means that discriminates between the conveyor belt and the workpiece. The sensor is also typically located near the delivery roller 140a, such that the workpiece is near the front end of the conveyor belt. When a signal is generated by the sensor 120, the carriage 150 moves forward in the direction of the arrow 128 while the forward feed speed of the belt 130 is stopped.

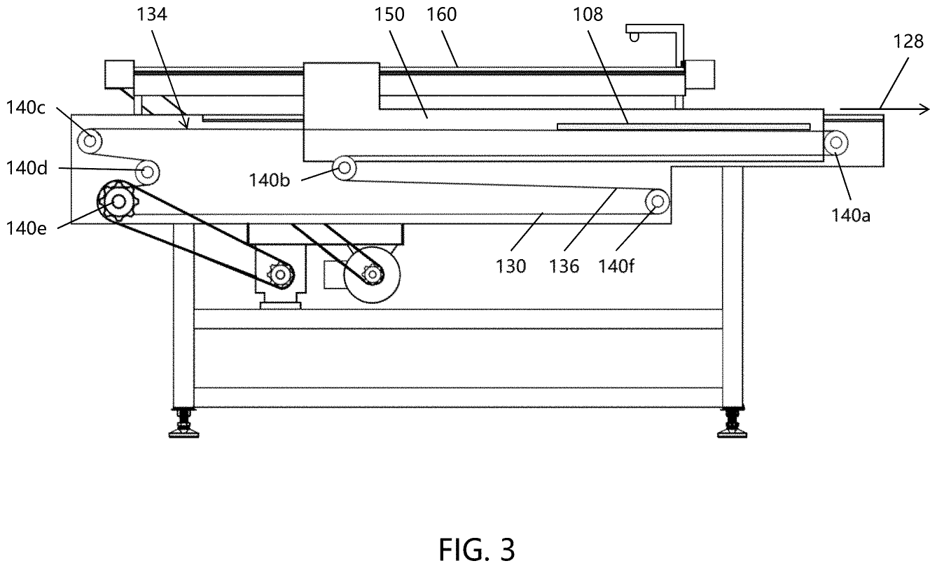

Referring now to FIG. 3, the carriage 150 and delivery roller 140a move forward together. Once the resistance of the sliding cam is overcome by the forward force applied by the actuator 160 to move the carriage 150, the sliding cam roller 140b is set in motion, being displaced toward the right. This motion of the sliding cam roller 140b maintains the belt 130 taut about rollers 140c-140e and 140f. In addition, this motion of the sliding cam roller 140b permits the upper belt run 132 to extend in length and the lower belt run 136 to decrease in length. Thus, it should be noted that the longitudinal distance between delivery roller 140a and moving roller 140b does not remain constant, but is bounded between a minimum value and a maximum value. The support surface 134 defined by the belt 130 maintains its forward speed while the carriage is moving forward, thus keeping satisfactory forward transportation of the workpieces 108.

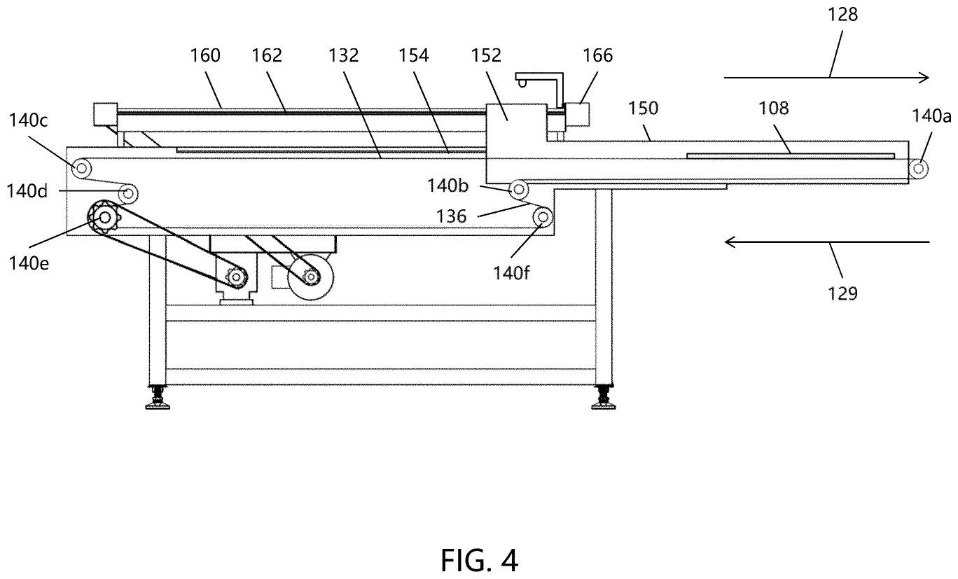

The carriage 150 is moved further forwardly in the direction of arrow 128 until the carriage reaches its fully extended position illustrated in FIG. 4. Once in the fully extended position of FIG. 4, the upper belt run 132 has reached its maximum length, the lower belt run 136 has reached its minimum length, and the workpiece 108 is ready for deposition at the downstream workstation. To deposit the workpiece 108, the carriage 150 and delivery roller 140a move rearward in the direction of arrow 129 while the belt 130 restarts its forward feed speed in the direction of arrow 128. This causes the workpiece 108 to roll off the end of the conveyor belt and be deposited on the downstream workstation 104 (see FIG. 1). The rearward movement speed of the carriage 150 is desirably the same as the forward feed speed of the conveyor belt 130. As a result, the speed of each workpiece 108 is almost zero as it rolls off the end and is deposited, and there is no pushing or sliding process which could cause the flexible workpieces to fold over or otherwise bunch up and form an unstable, disorderly stack of workpieces.

While the carriage 150 moves rearward in the direction of arrow 129, the sliding cam roller 140b is also displaced rearward by a biasing member, such as a spring (not shown). This motion of the sliding cam roller 140b maintains the belt 130 taut about rollers 140c-140e and 140f, while the upper belt run 132 decreases in length and the lower belt run 136 increases in length. Once the actuator 160 moves the carriage 150 back to its starting position illustrated in FIG. 2, a new deposition process as described above can be initiated. The workpieces 108 are thereby securely deposited to form a stack 109 of workpieces (see FIG. 1) as additional deposition cycles are completed.

The process described above, where the forward feed speed of the belt 130 is cut to zero as the carriage extends and then restarts as the carriage retracts, causes the workpiece to be deposited in the same orientation as it was placed on the conveyor belt (e.g. face-up). It is also contemplated that the stacking device can be used to flip the workpiece to the opposite orientation (e.g. from face-up to face-down). This could be accomplished by maintaining the forward feed speed of the belt 130 as the carriage extends.

It is also noted that because fixed roller 140c does not move, the support surface 134 is always present at the receiving end of the device. As a result, a subsequent workpiece could be received by the stacking device 102 while the carriage is still retracting back to its starting position. This could permit the distance between workpieces to be decreased, increasing workpiece throughput.

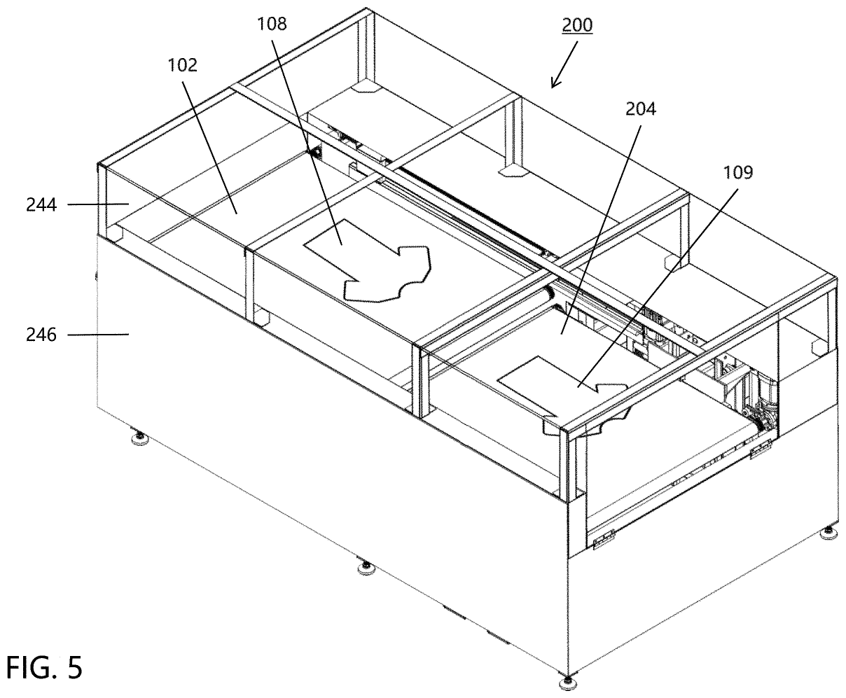

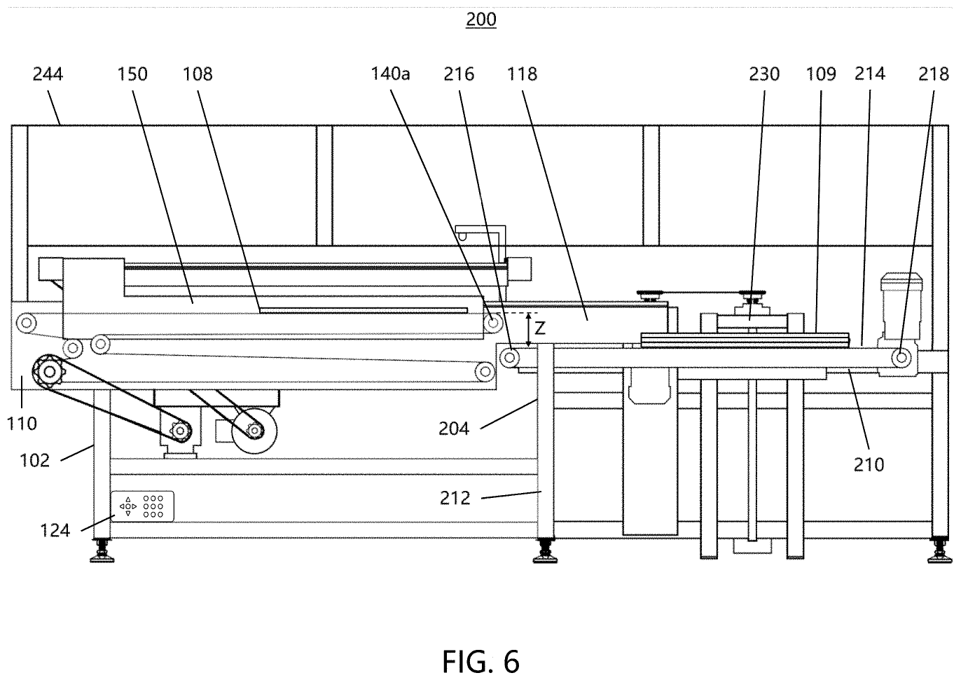

In another embodiment of the present disclosure, a system 200 for processing thin textile workpieces is illustrated in FIG. 5 and FIG. 6. In particular, the system 200 in FIG. 5 and FIG. 6 includes the stacking device 102, which operates in the manner described above, in operative association with a downstream workstation 204. The downstream workstation 204 is a height-adjustable stacking table which receives the workpieces 108 from the stacking device 102 and supports the workpieces in stacked form 109.

An optional housing arrangement which fully encloses the system 200 is shown in FIG. 5 as including an upper transparent housing 244 made of clear panels (e.g., LEXAN®) and a lower safety housing 246 for covering the components of the system and protecting users therefrom. The lower housing 246 is not illustrated in FIG. 6, to permit easier understanding of the operation of the stacking device 102 with the stacking table 204.

Referring now to FIG. 6, the stacking table 204 is comprised of a horizontal platform 210 which is vertically moveable on a support framework 212 via a height adjustment mechanism 230. The platform 210 can support a conveyor belt 214 to provide the receiving surface on which workpieces 108 are deposited. When operatively associated with the stacking device 102, the stacking table 204 is generally positioned under the carriage 150. As such, when the carriage 150 is in its fully extended position (as described above and shown in FIG. 4), the delivery roller 140a is positioned above the stacking table 204 at a deposition location where it is desired to form the stack 109. The vertical distance Z or depositing height through which the workpieces fall during the deposition process can be made relatively small, thereby ensuring a satisfactory depositing of the workpieces without requiring that they be moved, displaced, or pushed.

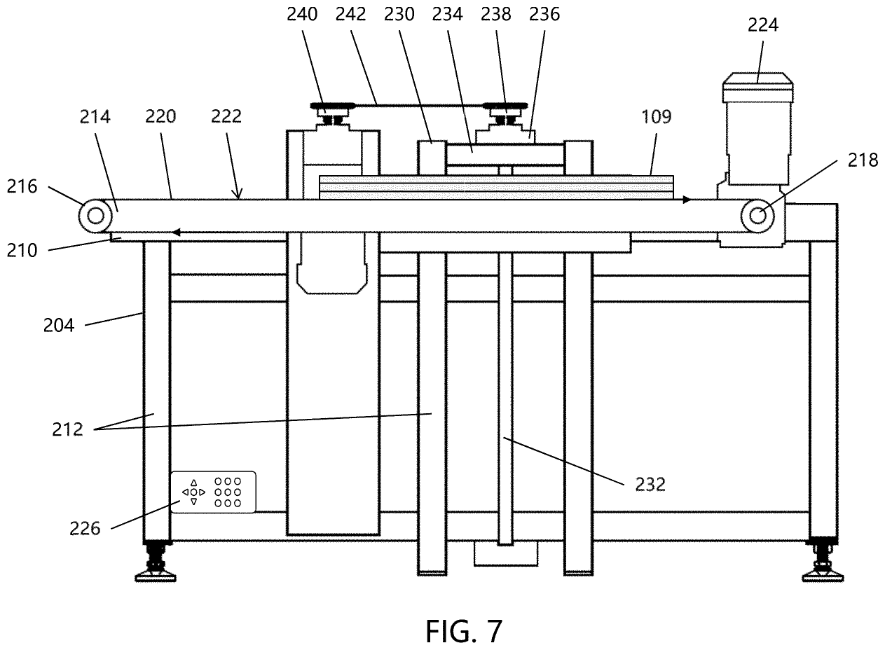

FIG. 7 shows additional details of the stacking table 204. The platform 210 supports the conveyor belt 214, which extends between a first end roller 216 and a second end roller 218 to provide an upper belt run 220. The upper belt run 220 defines a support surface 222 for supporting the stack 109 of workpieces being formed by the stacking device 102. The second end roller 218 is operatively engaged with motor 224 to drive the conveyor belt 214 in the direction indicated by the arrows shown in FIG. 7. Moreover, motor 224 is in operative connection with a control mechanism 226 for adjusting and controlling the feed speed of the conveyor belt 214.

As mentioned above, platform 210 of the stacking table 204 is vertically moveable on support framework 212 via a height adjustment mechanism, such as a rotary screw jack 230. The rotary screw jack 230 is generally comprised of a screw 232; a nut 234 to which platform 210 is mounted, the nut 234 being operatively engaged with the screw for vertical travel up and down the screw; a gear box 236; an input sprocket 238; and a motor 240 operatively engaged with the input sprocket via chain or belt 242. Motor 240 is also in operative connection with control mechanism 226 for adjusting and controlling the height of the platform 210 and conveyor belt 214 of the stacking table 204. It is noted that the motor shaft could be moved and shaped to operate as the screw, such that a chain or belt 242 is not needed. In addition, control mechanism 226 is in operative connection with control mechanism 124 of the stacking device 102. Alternatively, a single control mechanism 124 can be used for both stacking device 102 and stacking table 204.

Once a workpiece is deposited onto the stacking table 204 by the stacking device 102 in the manner described above, the controller 226 activates the motor 240, lowering the platform 210 and conveyor belt 214 far enough to receive another workpiece from a subsequent deposition process. The platform 210 and conveyor belt 214 should lower in height by the same amount as the stack 109 increases. When a desired number of workpieces have been stacked by the stacking device 102 onto the conveyor belt 214, the completed stack 109 can be removed manually or the controller 226 can activate motor 224 to drive the belt 214 forward, moving the completed stack to a final location or to another workstation. In this regard, the controller 226 may instruct the activation of motors 224/240 based on the count of workpieces measured by sensor 120. When the stack 109 is removed, the controller 226 again activates motor 240 to raise the platform 210 and conveyor belt 214 back to the starting position where another stack can be formed.

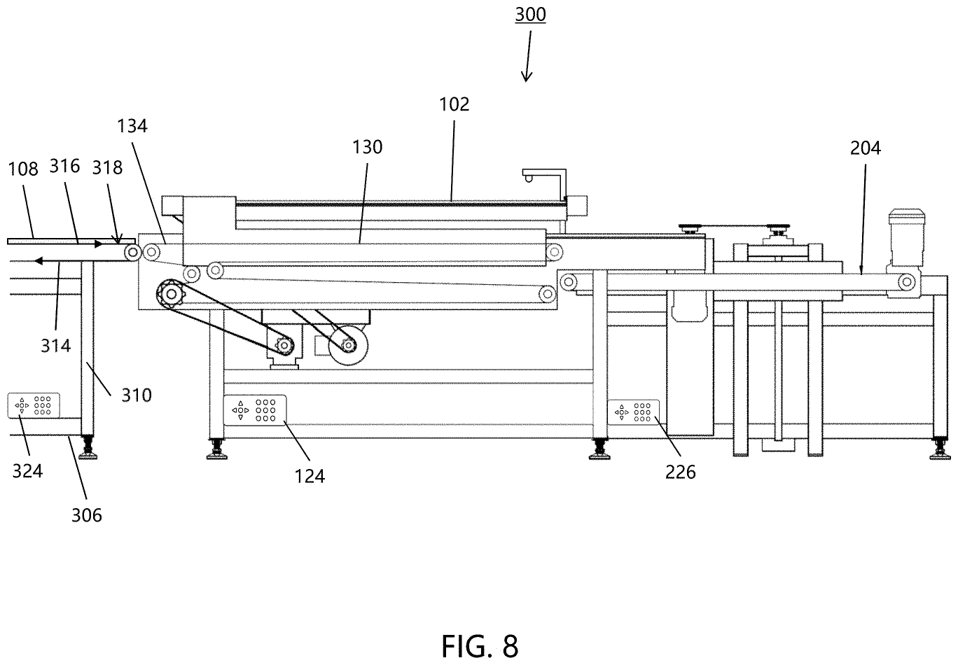

In another embodiment of the present disclosure, a system 300 for processing flexible textile workpieces is shown and described with reference to FIG. 8. The system 300 includes the stacking machine 102, which operates in the manner described above, in operative association with a downstream workstation 204, which can be configured as a height-adjustable stacking table like that described in FIGS. 5-7. The system 300 further includes an additional workstation 306 positioned upstream of the stacking device 102. The workstation 306 can be a dryer conveyor commonly used in a processing line where ink or paint applied to the workpieces is dried before advancing to a subsequent downstream workstation.

The dryer conveyor 306 is generally configured in operative association with the stacking device 102 to feed or transport workpieces 108 to the stacking device. The dryer conveyor 306 is generally comprised of a base frame 310 supporting a conveyor belt 314 which extends between rollers to provide an upper belt run 316. The upper belt run 316 defines a support surface 318 for supporting the workpieces 108 being delivered by the dryer conveyor 306. The conveyor belt 314 is moveable in the direction indicated by the arrows shown in FIG. 8 and is controlled by a control mechanism 324 for adjusting and controlling the feed speed of the conveyor belt.

When the dryer conveyor 306 is operatively associated with the stacking device 102, the support surface 318 of the upper belt run 316 of conveyor belt 314 is located above or coplanar with the support surface 134 defined by the upper belt run 132 of the stacking device conveyor belt 130. The feed speed of the dryer conveyor belt 314 is generally slower than the speed of the conveyor belt 130 of the stacking device 102. As such, a satisfactory transference of the workpiece 108 from the dryer conveyor 306 to the stacking device 102 is ensured without a pushing or sliding process which could cause the thin flexible workpieces to fold over or otherwise bunch up, eventually resulting in an unstable, disorderly stack of workpieces formed at the stacking table 204.

In some embodiments, the dryer conveyor belt 314 operates at a feed speed which is about 60 to 75 percent the feed speed of the stacking device conveyor belt 130. In some particular embodiments, the feed speed of the dryer conveyor belt 314 is about 18 to 22 feet per minute, while the feed speed of the stacking device conveyor belt 130 is about 30 feet per minute. If desired, an air drying or cooling mechanism, such as a fan or air curtain, could be located at the first end of the stacking device which is directed at the conveyor belt for drying/cooling the workpiece received from the dryer conveyor belt.

Moreover, control mechanisms 124, 226, and 324 are in operative connection with one another to ensure proper operation between each workstation 102, 204, 306. Alternatively, the control mechanism 124 of the stacking device can be configured as the sole controller for each workstation 102, 204, 306. In this regard, the extendable conveyor belt 130 of the stacking device 102 can be calibrated with a feed speed which permits optimal operative association with the dryer conveyor belt 314. Generally, the extendable conveyor belt is calibrated based on factors such as desired speed, length of the workpieces, and/or thickness of the workpieces. Thickness is important for height calibration of the adjustable stacking table 204 which lowers as workpieces are stacked.

It is also noted that if desired, slip sheets could be inserted between the textile workpieces. This could be done by laying slip sheets on the conveyor belt between textile workpieces. Such slip sheets can also be deposited on the stack using the same mechanisms and methods described herein.

To aid the Patent Office and any readers of this application and any resulting patent in interpreting the claims appended hereto, it is not intended for any of the appended claims or claim elements to invoke 35 U.S.C. § 112(f) unless the words “means for” or “step for” are explicitly used in the particular claim.

The present disclosure has been described with reference to exemplary embodiments. Modifications and alterations will occur to others upon reading and understanding the preceding detailed description. It is intended that the present disclosure be construed as including all such modifications and alterations insofar as they come within the scope of the appended claims or the equivalents thereof.

1. A system for handling textile workpieces comprising:
a first workstation including a support surface from which workpieces are fed;
a stacking device workstation including a stationary frame, a workpiece receiving end, a workpiece depositing end, a linearly displaceable carriage mounted to the stationary frame and moveable between a starting position and a fully extended position, a conveyor belt with a support surface to receive and transfer said workpieces from the first workstation, and a plurality of rollers engaged with the conveyor belt, the plurality of rollers comprising:
a driver roller mounted on the stationary frame, at least two fixed support rollers mounted on the stationary frame, a moving roller mounted below the carriage, and a delivery roller mounted on a front end of the carriage,
wherein the moving roller and the delivery rollers move relative to the fixed support rollers and stationary frame to change a length of the conveyor belt; and
a second workstation including a support surface to receive said workpieces from the workpiece depositing end of the stacking device.

2. The system of claim 1, wherein the stacking device workstation further comprises a linear actuator configured to linearly displace the carriage between the starting position and the fully extending position.

3. The system of claim 1, wherein the stacking device workstation further comprises a sensor disposed above the stacking device conveyor belt for detecting the presence of workpieces.

4. The system of claim 1, wherein the second workstation is a height-adjustable stacking table.

5. The system of claim 1, wherein a support surface of the second workstation is positioned below the support surface of the stacking device conveyor belt.

6. The system of claim 1, wherein the first workstation is a dryer conveyor positioned upstream of the stacking device, the dryer conveyor including a conveyor belt defining a support surface from which workpieces are fed.

7. The system of claim 6, wherein the support surface of the dryer conveyor belt is above or coplanar with the support surface of the stacking device conveyor belt

8. A stacking device for transferring workpieces between an upstream workstation and a downstream workstation, the stacking device comprising:
a stationary frame, a workpiece receiving end, and a workpiece depositing end;
a linearly displaceable carriage mounted to the stationary frame and moveable between a starting position and a fully extended position;
a conveyor belt with a support surface to receive said workpieces from the upstream workstation and transfer said workpieces to the downstream workstation; and
a plurality of rollers engaged with the conveyor belt and extending between the sidewalls, the plurality of rollers comprising a driver roller mounted on the stationary frame, at least two fixed support rollers mounted on the stationary frame, a moving roller mounted below the carriage, and a delivery roller mounted on a front end of the carriage,
wherein the moving roller and the delivery rollers move relative to the fixed support rollers and stationary frame to change a length of the conveyor belt.

9. The stacking device of claim 8, further comprising a sensor disposed above the conveyor belt for counting and detecting the presence of workpieces, the sensor being operatively connected with the controller.

10. The stacking device of claim 8, further comprising a linear actuator and an associated motor configured to move the carriage between the starting position and the fully extending position, the linear actuator and associated motor being operatively connected with the controller.

11. The stacking device of claim 8, further comprising two mutually parallel sidewalls supported by the stationary frame.

12. The stacking device of claim 11, wherein the sidewalls include a cantilevered portion defining a protrusion which extends toward the downstream workstation.

13. The stacking device of claim 11, wherein the sidewalls include longitudinal tracks on which the carriage is guided between the starting position and the fully extended position.

14. The stacking device of claim 8, further comprising a motor for moving the conveyor belt and a controller for controlling the operation of the conveyor belt and the carriage, the motor being operatively connected with the controller.

15. A method for stacking workpieces, comprising:
receiving a workpiece at a stacking device that comprises:
a stationary frame, a workpiece receiving end, and a workpiece depositing end;
a linearly displaceable carriage mounted to the stationary frame and moveable between a starting position and a fully extended position;
a conveyor belt with a support surface to receive said workpieces from the upstream workstation and transfer said workpieces to the downstream workstation; and
a plurality of rollers engaged with the conveyor belt and extending between the sidewalls, the plurality of rollers comprising a driver roller mounted on the stationary frame, at least two fixed support rollers mounted on the stationary frame, a moving roller mounted below the carriage, and a delivery roller mounted on a front end of the carriage,
wherein the moving roller and the delivery rollers move relative to the fixed support rollers and stationary frame to change a length of the conveyor belt;
rotating the conveyor belt at a forward feed speed so that the workpiece travels to a front end of the carriage;
moving the carriage from the starting position to the fully extended position such that the length of the conveyor belt increases; and
moving the conveyor belt at the forward feed speed while moving the carriage from the fully extended position to the starting position, such that the workpiece travels off the conveyor belt while the length of the conveyor belt decreases, and the workpiece is stacked.

16. The method of claim 15, wherein the carriage moves from the starting position to the fully extended position when a sensor disposed above the stacking device conveyor belt detects the presence of the workpiece at the front end of the carriage.

17. The method of claim 15, wherein the forward feed speed of the conveyor belt is reduced to zero while the carriage moves from the starting position to the fully extended position, such that the workpiece is stacked in its original received orientation.

18. The method of claim 15, wherein the forward feed speed of the conveyor belt is maintained while the carriage moves from the starting position to the fully extended position, such that the workpiece is flipped from its original received orientation.

19. The method of claim 15, wherein the stacking device receives the workpiece from an upstream conveyor belt.

20. The method of claim 19, wherein a feed speed of the upstream conveyor belt is from about 60 to 75% of the forward feed speed of the stacking device conveyor belt.
